(19) United States
(12) Patent Application Publication
(10) Pub. No.: US 2017/0161444 A1
(43) Pub. Date: Jun. 8, 2017

(54) METHOD AND APPARATUS FOR PROVIDING A HEALTH CARE ACCOUNT-RECEIVABLES BOND FUND

(71) Applicant: Endeavor Plus,Inc., New York, NY (US)

(72) Inventors: JAMES L. SCHMIDT, Pensacola, FL (US); PASQUALE DILEO, Tom Rivers, NJ (US)

(21) Appl. No.: 15/372,727

(22) Filed: Dec. 8, 2016

Related U.S. Application Data
(60) Provisional application No. 62/264,553, filed on Dec. 8, 2015.

(51) Int. Cl. G06F 19/00; G06Q 40/06

(52) U.S. Cl. CPC G06F 19/328; G06Q 40/06

(57) ABSTRACT

Method and apparatus for securitizing accounts receivables (A/R) of healthcare providers (HPs) which have obligors that are obliged to make payments to the HPs for health care provided by the HPs to insured/covered persons, has at least one HP selling it's A/R to an independent Receivable Acquisition entity (RAe) at a discount from face value of the HP A/R. The RAe generates Bond funds from investors who wish to purchase HP A/R Bonds, placing the HP A/R in escrow in a bank. The RAe receives the obliged payments from the obligors at the face value of the HP A/R. The investors receive coupon and final payments from the HP A/R Bonds via the bank. Preferably, the purchase of the HP A/R is a fee simple sale of ownership, whose payment is guaranteed by a Passive Portfolio Note (PPN) issued by the RAe to a Special Purpose Cell entity that places the investor funds into the bank.

This application claims priority to U.S. Patent Appln. No. 62/264,553, filed Dec. 8, 2015, the contents of which is incorporated herein by reference.

### FIELD OF THE INVENTION

The present invention relates to methods and apparatus for creating and managing a health care Account Receivables (A/R) bond fund, and more particularly to the creation of a new bond instrument whereby healthcare receivables can be securitized in an investment-market environment, thus providing liquidity to the health care institutions.

### BACKGROUND OF THE INVENTION

Currently, healthcare providers (called Exclusive Provider Organizations or EPOs, e.g., hospitals, doctors, etc.) provide medical services to people who need them. Such people typically have health insurance (often, one or more companies) which pay(s) the EPOs for the care that the EPOs provide to the insured/covered patient(s). As is well known, such subsequent payments to EPOs are often delayed and are usually reduced. Due to inefficiencies and delays in payment of claims submitted, healthcare providers often experience liquidity problems because of (i) entities (insurance companies, patients, etc.) that owe the EPOs for services rendered (providing care), but are late in payments, and/or (ii) difficulties the EPOs may experience in their overall cash management systems.

This break in the flow, momentum, and availability of funds constitutes a serious financial impediment for healthcare providers in regards to paying for not only continuing operations but capital improvements. This slow/low payment by the insurance companies also impacts both the assessment and perception of equitable value and borrowing capability of the EPOs, impeding the continuing provision of healthcare and contributing to an increase in healthcare costs to consumers.

Thus, what is needed is a new securities offering that provides liquidity to the EPOs and relieves them of the burdens of the delays and uncertainties of their receivables repayment, providing a continuing access to funds on a non-correlated risk basis relative to the credit-worthiness of the providers.

### SUMMARY OF THE INVENTION

The present invention aims to overcome the problems of the prior art, including the delays and uncertainties of the subsequent payments to EPOs, through the creation of a new form of securities offering called a HEALTH RECEIVABLES BOND (HRB). The design of this new security relates to the method and apparatus for investing in and securitizing hospital and medical receivables on a mass scale, preferably using an automated underwriting and acquisition process. Preferably, the present invention uses a system that incorporates: (i) the use of an instrument called a Passive Portfolio Note (PPN; as defined by Section 871(h) of the United States Internal Revenue Code), which functions as a promissory note and which serves as the note that backs funds advanced from the Health Fund Management Company, as the fund manager of the separate financial cell companies that originate and issue the individual series of HRBs, to independent Receivable Acquisition Company(s) (RACs); (ii) the use of an “absolute sale and purchase” structure whereby receivables are indexed/identified and “sold”, with the “fee simple” transfer; and “absolute assignment” of all rights and interests in the receivable to the purchaser; and (iii) the use of an accompanying “warranty of merchantability” of the receivable purchased whereby in addition to selling the receivable to the purchaser, a warranty of merchantability is provided, with the seller (the EPO that received the commitment to pay from the insurance company (provided on behalf of the actual patient/insured)); thus providing a guarantee that the obligor who is responsible for satisfying and paying the receivable will in fact pay; and thus that the receivable that has been sold is indeed merchantable or has the value represented when sold and purchased for a discount against its professed value.

The present invention thus provides a means for investors to invest in and securitize hospital and medical receivables, simultaneously providing liquidity to the EPOs and investment-grade securities to the investors.

According to a first aspect of the present invention, a method of securitizing accounts receivables (A/R) of healthcare providers (HPs) which have Obligors that are obliged to make payments to the HPs for health care provided by the HPs to insured/covered persons, includes: (i) providing a Health Fund Management entity (HFMe); (ii) providing a Receivable Acquisition entity (RAe); (iii) providing a Special Purpose Cell entity (SCe); (iv) the SCe issuing at least one Health Receivables Bond Series (HRBS) containing Health Receivables Bonds; (v) at least one bond investor purchasing at least one Health Receivables Bond of the HRBS, the purchase funds being deposited in a lock box account of a first bank; (vi) the SCe causing the funds deposited in the lock box account of the first bank to be transferred to a lock box account of a second bank; (vii) the RAe causing the funds transferred to the lock box account of the second bank to be transferred to at least one HP in exchange for the RAe receiving A/R of the at least one HP; (viii) the RAe issuing at least one Passive Portfolio Note (PPN) to the SCe, the PPN corresponding to the HBS; (ix) at least one Obligor making obliged payment(s) to the lock box account of the second bank, into an account held by the RAe; (x) upon PPN maturity, an amount needed to pay off the PPN is remitted from the lock box account in the second bank to the lock box account in the first bank; (xi) the SCe causing funds in the lock box account of the first bank to be provided to the at least one bond investor as Health Receivables Bond coupon and final payment(s) for the HRBS; (xii) the SCe causing the PPN for the HRBS for which it was issued to be paid off by transfer of funds from the lock box account of the first bank to the SCe; (xiii) the SCe causing financial fees to be paid to the RAe from the lock box account of the first bank; and (xiv) the SCe causing administrative fees to be paid to the HFMe from the lock box account of the first bank.

According to a second aspect of the present invention, a method of securitizing accounts receivables (A/R) of healthcare providers (HPs) which have Obligors that are obliged to make payments to the HPs for health care provided by the HPs to insured/covered persons, has at least one HP selling it's A/R to an independent Receivable Acquisition entity (RAe) at a discount from face value of the HP A/R. The RAe generates Bond funds from investors who wish to purchase HP A/R Bonds. The RAe receives the obliged payments from the Obligors at the face value of the HP A/R. The investors receive coupon and final payments from the HP A/R Bonds.

According to a third aspect of the present invention, apparatus for securitizing accounts receivables (A/R) of healthcare providers (HPs) which have Obligors that are obliged to make payments to the HPs for health care provided by the HPs to insured/covered persons, has at least one Health Fund Management entity (HFMe) server, and at least one Receivable Acquisition entity (RAe) server. At least one Special Purpose Cell entity (SCe) server is also provided; the at least one SCe server transmitting signals corresponding to the issuance of at least one Health Receivables Bond Series (HRBS) containing at least one Health Receivables Bond. The at least one SCe server also receiving signals from at least one server of at least one bond investor, the received signals corresponding the a purchase of at least one Health Receivables Bond of the HRBS, the received signals also indicating that the purchase funds are deposited in a lock box account of a bank. The at least one RAe server transmitting signals which cause the funds transferred to the lock box account of the bank to be transferred to at least one HP in exchange for the at least one RAe server receiving signals corresponding to the A/R of the at least one HP. The at least RAe server transmitting signals corresponding to the issuing of at least one Passive Portfolio Note (PPN) to the at least one SCe server, the PPN corresponding to the HBS. The at least one SCe server receiving signals indicating that at least one Obligor has made obliged payment(s) to the lock box account of the second bank, in an account held by the RAe. Upon PPN maturity, the at least one SCe server transmits signals causing funds in the lock box account of the bank to be provided to the at least one server of the at least one bond investor as Health Receivables Bond coupon and final payment(s) for the HRBS. The at least one SCe server issuing signals causing the PPN for the HRBS for which it was issued to be paid off by transfer of funds from the lock box account of the bank to the at least one SCe server. The at least one SCe server transmitting signals causing at least one of (i) financial fees to be paid to the at least one RAe server from the lock box account of the bank and (ii) causing administrative fees to be paid to the at least one HFMe server from the lock box account of the bank.

### BRIEF DESCRIPTION OF THE DRAWINGS

Certain aspects in accordance with embodiments of the present invention are described below in connection with the accompanying drawing figures in which:

FIG. 1 is a schematic block diagram of the structures according to the present invention;

FIG. 2 is a functional and notional diagram for explaining the functional features according to the FIG. 1 embodiment;

FIG. 3 is a functional and notional diagram for explaining the functional features according to another embodiment; and

FIG. 4 is a flow diagram for explaining a preferred process according to the FIG. 2 embodiment.

### DETAILED DESCRIPTION OF THE PRESENTLY PREFERRED EXEMPLARY EMBODIMENTS

### 1. Introduction

In overview, funds will be raised to subsequently invest through the sale of Bonds on a private placement basis (in compliance with Rule 506 (c) of Regulation D of the United States Securities Code). The basis of the solicitation of investors to purchase said Bonds will preferably be the creation of an asset-backed preferred debt instrument that uses the proceeds raised to acquire hospital and medical receivables on a mass scale. This is preferably achieved by using an automated underwriting and acquisition process to be described below, and through the use of the PPNs. Each series of Bonds will preferably be issued by a special purpose segregated cell company (SCC, a company administered and managed by a separate and distinct, bankruptcy remote, third-party administrative company). The SCC will serve as the company that will issue each Health Bond Series. The SCC will fund a receivable acquisition company(s) (RACs) which will then source Hospital receivables that it will purchase.

The funds raised from the sale of the Bonds described above preferably will be advanced through a structured method to certain independent RACs within the United States that will secure the advance of funds through the issuance of certain PPNs. The PPNs preferably will be issued for varying face amounts (the amounts may be determined by the capital raise of the bond) with a preferable maturity date of one year and a day from the issuance of the PPN, and preferably will be purchased by the above-mentioned SCCs from an RAC, and acquired for a negotiated and stipulated amount constituting a discount of the face by an estimated 65-99%, more preferably, 70-97%, even more preferably 75-90%, yet more preferably 80-95%, and most preferably 85-95%. Each PPN preferably will be ultimately collateralized by an initial pool of hospital and medical receivables that have been acquired by an RAC at a price preferably equal to the purchase price of a PPN. As receivable obligations are paid by their respective obligors, funds preferably will be advanced again out of a secure escrow (lock box) account to acquire substitute collateral (more receivables). All funds transmitted to purchase a PPN from the RAC preferably will be held in a structured lock box (preferably a custodial account controlled by an institutional party with both commercial banking and trust powers and authority acquired from a State or the Federal Government of the United States) in a structured escrow arrangement. Preferably, at all times said structured escrow account will contain either funds or receivables, acquired with the use of the funds by an RAC to collateralize and secure the repayment of their PPN obligation, of a value equivalent to or exceeding the initial amount of the Bond proceeds transferred into the structured escrow account.

Preferably, each RAC will be instructed as to the criteria and requirements associated with the PPN purchase requirements of each SCC. Each RAC preferably will be permitted to initially contract to acquire and purchase hospital and medical receivables using the funds that have been placed into escrow prior to the closure of the purchase and sale of the PPN, to provide the initial collateral to support the PPN, with each sale and purchase of a receivable being construed contractually and commercially as an absolute sale and purchase structure with an accompanying warranty of merchantability of the receivable purchased. Preferably, a pre-condition of utilizing the initial Bond proceeds (transferred into a dedicated structured escrow account controlled and managed by the independent custodial party mutually agreed to by the respective SCC that issued the particular Series of Bond) will be that the obligor of each receivable purchased by a RAC will be informed of their obligation to remit payment(s) directly into the escrow (lock box) account in regards to liquidating their obligation evidenced by a receivable document. Preferably, all funds utilized to purchase said receivables (pursuant to the terms and conditions previously mentioned herein) shall be conveyed directly from the structured escrow (lock box) account to the seller of the receivable (the healthcare provider who is owed the receivable obligation by the insurance company).

In regards to Bonds of multiple years in duration, the PPNs of a year and one day maturity are preferably acquired sequentially to assure asset-backed securitization, assuring either cash or a collateralized PPN shall be in the segregated secure account established for each SCC by the third-party administrative company, the Health Fund Management Company (the fund administrator for the SCCs who actually issue the individual series of Bonds).

The benefits of the presently preferred embodiments include: (A) provides investors with a: (i) high yielding, (ii) investment-grade, (iii) high-quality, and (iv) short-term maturity investment—a combination of attributes that is rare in a fixed-income instrument (Bond); (B) provides hospitals and healthcare providers with greater liquidity that enables them to engage in activities that build their patron and operational base and continue to provide care; and (C) closely aligns the interests of EPOs, reinsurers, self-insurance providers, and employers—and in doing so, creates healthier populations and drive down healthcare costs.

As used herein, a “server” is a computer machine and or a computer program embodied in a machine that typically waits for requests from other machines or software (clients) and responding to them. The purpose of a server is to share data or hardware and software resources among clients. This architecture is called the client-server model. The clients may run on the same computer or may connect to the server over a network. Typical computing servers are database servers, file servers, mail servers, print servers, web servers, game servers, and application servers. Server machines (which can be either actual or virtual machines) run server programs. In turn, a server program turns the machine on which it runs into a server machine. However, designating a machine as “server-class hardware” implies that it may be more powerful and reliable than standard personal computers or is specialized for performing the server's role. Servers may be composed of large clusters of relatively simple, replaceable machines. The servers disclosed herein may include one or more processors, and/or one or more personal computers and/or one or more laptops, and/or one or more pads, and/or one or more cloud-computing structures, and any other computing platform through which the functions described herein may be accomplished. The operations of the Bond fund(s) according to the present invention will be greatly enhanced due to the speed of the servers involved, thus greatly reducing transaction time(s). Further, the sheer number of Bonds in the various State and/or Federal jurisdictions can be efficiently traded via such servers, reducing paperwork. Each US state preferably has $10 M per year in such healthcare receivables which are subject to securitization as mentioned above and described below, providing $840 M in bonds over the first six years of operation.

### 2. Structures and Functions

In greater detail, the present invention proposes to provide a new means to give liquidity to healthcare providers who accept insurance assignments and commitments to subsequently pay for the care received by an insured patient, through the creation of a new form of securities offering, a HEALTH RECEIVABLES BOND (HRB), and for underwriting the repayment of health care costs, by creating a new Bond market together with new systems for operating the Bond market.

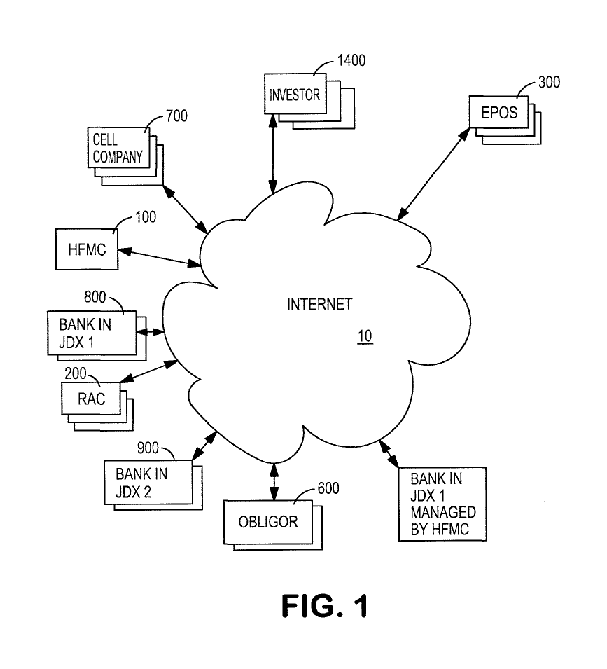

With reference to FIG. 1, health care entities, such as hospitals and hospital networks (e.g., EPOs) each have one or more servers (and/or processors and/or computers and/or shared systems) 300 which preferably communicate with the other entities to be described below, through a Wide Area Network, such as the Internet 10. The EPOs (also referred to herein as “300” for convenience) are provided with immediate liquidity through the purchase of the EPOs' medical receivables (as stored on the servers 300) preferably at a discount to contractual value. The discount may be 1-30%; 2-25%; 3-20%; 4-15%; 5-10%; 10%, or any mutually acceptable discount. Such receivables represent payment obligations of investment-grade rated companies, owed to the EPOs, which due to purchase preferably have no risk correlation to the EPO selling the receivable. EPO providers are preferably provided with funding in regards to receivables and large catastrophic claim obligations; for example, a catastrophic claim is one for a dollar value that generally exceeds the deductible paid by an employer and can reach in the tens of thousands of dollars and up in to the millions of dollars. The parameters for determining catastrophic claims are those that involve a complex illness or medical event like cancer or a heart attack. The payment of such obligations can be spread out over time, providing both EPO providers and their reinsurers with a more predictable cash flow. The HRB can be used for catastrophic claims only, and/or for any value of receivable. For example, the HRB will preferably purchase a hospital receivable that is owed by Aetna, Cigna or any other payer. Such a receivable can be a combination of many small claims or a few large claims. The notable feature is that the HRB relieves a hospital of waiting to be paid. The HRB steps in and buys that receivable at a discount and then collects the payment at face value from the payer.

Preferably, funds flow from investor(s) in the HRBs through their one or more servers, etc. 1400, into a secure escrow account of the special purpose financial SCC's one or more servers 700 established to issue each Series of HRB, to a secure (lock box) account of each independent RAC's one or more servers 200, to the sellers of receivables (healthcare providers) one or more servers 300. The flow of funds, of course, is indicated by transmission and reception of server signals corresponding to the transfers discussed herein.

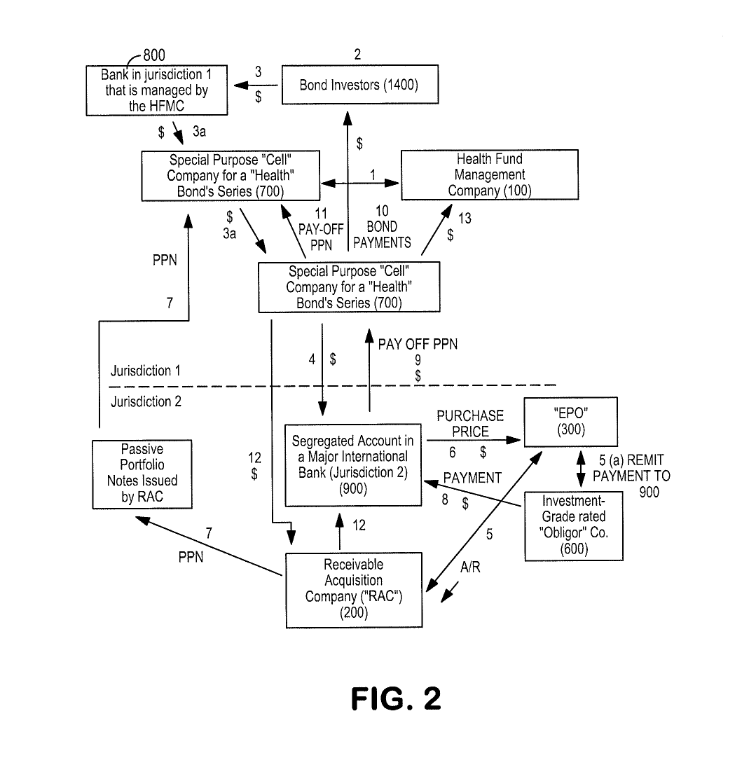

Referring to FIGS. 1 and 2, one preferred embodiment will be described with certain non-limiting numerical examples provided for clarity. The following steps outline the structures that facilitate how Bond capital is raised and the structures that facilitate the flow of capital between legal entities and healthcare providers. In this first embodiment, on-shore and off-shore banks may be used for certain tax and/or jurisdictional advantages. Preferably, a Health Fund Management Company (having one or more servers 100) (HFMC 100 for short; the Bond issuer) is established/provided to facilitate the issuance of Bonds (by the special purposes SCCs 700 established to issue each Bond), and to serve in the role as the fund administrator and fund manager. Preferably, each HFMC 100 will facilitate the issue of multiple Bonds of different (dollar) sizes, coupons (interest rate paid to Bond investor), and maturities (the termination or due date on which an installment loan preferably will be paid in full) in any given year. The number of Bonds and the size of the Bonds (that are issued) are driven by (i) the EPO's need for capital, (ii) the availability of healthcare provider's medical receivables to purchase, and (iii) the willingness of the EPO 300 to sell their medical receivables. At least one HFMC, RAC, and SCC is preferably provided in each state.

For example, the HRBs preferably will be issued in a Series as expressed in the following examples of three health Bonds of different sizes, coupons, and maturity dates: Health Bond Series 1: $10 million, 3-year Bond with an 10% coupon; Health Bond Series 2: $20 million, 5-year Bond with a 12% coupon; and Health Bond Series 3: $30 million, 10-year Bond with a 15% coupon. For the purposes of the present embodiment, for example, Health Receivable Bond Series 1, a $10 million, 3-year Bond with a 10% coupon will be used. The HFMC 100 preferably establishes a SCC 700 for each Health Bond series. For example, a SCC company is provided for Health Bond Series 1. For example, accredited and/or institutional Investors 1400 are solicited and invest in Health Bond Series 1. Signals to and from the investors 1400 may be carried out through their server(s) or to their cell phones via WiFi if, for example, one or more of their server(s) is/are busy or down. Further, each investor may be provided with a paper/physical and/or virtual HRB token, certificate, and/or award, etc., which demonstrates his/her social consciousness in investing in such a worthwhile fund.

Preferably, the proceeds from the sale of Health Bond Series 1 are deposited into a segregated, lockbox account with a major bank having at least one servers 800 (bank 800 for short; preferably located in jurisdiction 1, e.g., off-shore) in the name of the SCC provided for Health Bond Series 1. Preferably, one or more RAC having one or more servers 200 (RAC 200 for short)—is established to purchase receivables from the EPOs 300. Each RAC makes a profit derived, at least, from the difference between the (i) cost of funds obtained through the issuance of a PPN and (ii) the revenue generated from the discounted price paid for the receivable(s).

Preferably, the Bond proceeds that are held in the lockbox (preferably in the name of the SCC company provided for Health Bond Series 1) at the bank 800 (in jurisdiction 1) are transferred to a segregated lockbox account located at a second bank (preferably located in jurisdiction 2, e.g., on-shore) having one or more servers 900 (bank 900 for short) managed by the RAC. With such funds, the RAC 200 will purchase medical receivables from EPOs 300. Such funds are held in escrow. Preferably, these funds will be continuously held in the segregated Trust Accounts of the bank(s) 900 pending utilization for the purchase of medical receivables from credit-qualified EPOs 300. Note that the banks 800 and 900 do not have to be located off and on-shore, respectively. In fact, they could be the same bank. For some investors who want certain tax advantaged accounts, however, the on and off-shore structure can be used.

Preferably, the EPOs 300, due to liquidity needs or a liquidity/value decision, agree to sell their medical receivables, which represent payment obligations of investment-grade rated companies (Obligors) to EPOs 300. The EPOs sell their receivables to the RAC which preferably buys the receivable at a discount. The RAC then collects payment at face value from the obligor that owed the EPO for medical services rendered. The RAC 200 then agrees to purchase the EPO 300 medical receivables. Obligors having one or more servers 600 are preferably notified in writing to remit payment to a segregated lockbox account (preferably managed by the RAC 200) at the bank 900 (in jurisdiction 2) versus remitting payment to the EPO.

Preferably, payment for the purchase of the medical receivables sold by EPOs 300 is initiated by the RAC 200 and made directly from the segregated lockbox of the bank 900 (in jurisdiction 2) to the EPOs 300 (sellers of the medical receivables). At this stage, the EPOs 300/healthcare provider(s) preferably have received discounted payment for their medical receivables, and the ownership of the medical receivable has been transferred to the RAC 200. The obligors 600 will preferably pay full face value for the medical receivables to the RAC 200, versus the EPO 300, at any time within, for example, 90 days.

When sufficient receivables are purchased to close out escrow (e.g., utilize all the proceeds of Health Bond Series 1), the RAC 200 preferably issues a Passive Portfolio Note (PPN) (which functions as a Promissory Note) to the SCC 700 that represents Health Bond Series 1. This PPN represents an obligation of the RAC to pay the SCC (which is preferably managed by the HFMC 100 on behalf of the Bond investors 1400) the value of the note. The obligors 600 are ready to pay and remit payment directly into the segregated lockbox account of the RAC 200 at the bank 800 in jurisdiction 1 (e.g., within a period of 90 days or so). At this stage, the obligors have paid in full.

The Passive Portfolio Note preferably exists for a minimum of one year and a day. This means that the RAC 200 will return the total value of the PPN to the SCC that issued the Bond series (in this example, Health Bond Series 1); the HFMC 100 issues any interim coupon payments associated with the Bond series on behalf of the SCC that issued the respective Bond series. During the year and a day term, the RAC 200 is expected to initiate the buy-and-collect process of receivables multiple times a year. The term “buy” means the purchase of receivables from a hospital or physicians (EPO) or other healthcare provider. The term “collect” means to collect from the entity or the debtor that owed the hospital (EPO) in the first place. The number of times that the funds turn over within a specific PPN is dependent, at least on one or more of: (i) the EPO's need for capital, (ii) the availability of healthcare provider medical receivables to purchase, (iii) the willingness of the EPO 300 to sell their medical receivables, and (iv) how quickly the obligors pay (preferably, contractually within 90 days).

### 3. Processes

With respect to FIG. 2, the preferred flow of activity of an embodiment where off-shore and on-shore banks are used is as follows. At step 1, the HFMC 100 establishes/provides the SCC 700 to issue a Health Bond Series. At Step 2, accredited and institutional investors 1400 are solicited and they purchase the Health Bond Series. At Step 3, the proceeds from the sale of Health Bond Series are deposited into a segregated, lockbox account, preferably, with a major international bank 800 in jurisdiction 1 that has been established for a specific health bond. In Step 4, funds are transferred from one lockbox account in the Bank 800 (jurisdiction 1) to a corresponding segregated lockbox account located in a second Bank 900 (jurisdiction 2) to be made available and to be advanced, in escrow, to RACs to purchase receivables (that are the payment obligations of investment-grade rated companies (obligors 600) to the EPOs.

In Step 5, EPO providers 300 agree to sell their receivables to the RAC 200. Obligors 600 are notified by the EPO, preferably in writing, to remit payment to a segregated lockbox account in the bank 900 (in jurisdiction 2), in Step 5a. Payment for the purchase of the receivables sold by the EPO is preferably made directly from the segregated lockbox of the bank 900 in jurisdiction 2 to the EPO in Step 6. When sufficient receivables are purchased to close out escrow (e.g., utilize all the proceeds of Health Bond Series 2015-1), a PPN is issued by the RAC 200 to the SCC 700 in Step 7.

In Step 8, obligors 600 of receivables remit payment directly into segregated lockbox account at bank 900 in jurisdiction 2. Upon PPN maturity, the amount needed to pay off the PPN issued by the RAC 200 is remitted from the bank 900 in jurisdiction 2 to the segregated lockbox account of the SCC in the bank 800 in jurisdiction 1,in Step 9. In Step 10, the SCC 700 remits dividends (coupon) and/or final payment (e.g., sends instructions to the bank 800 account in jurisdiction 1, where the funds are held for this bond series, to pay) on the Health Bond Series that it issued—to the bond holders 1400. The PPN for the health bond series for which it was issued is paid off in Step 11 from the bank 800 to the SCC 700. In Step 12, the Origination and Purchase (financial) fees earned by the RAC 200 are paid by the bank 800 in jurisdiction 1; and the Administrative and management fees are paid by bank 800 to the HFMC 100 in Step 13. In step 10a is the return of the money (upon maturity of the PPN) held in the RAC, (which is the result of the collection of the receivable) to the segregated account at the bank which ultimately arrives to the HFMC.

A Bond fund is preferably set up in each US state (or Canadian province, or other country sub jurisdictions), where individual state regulatory provisions may apply with respect to such Bond funds. The HFMC 100 investigates such state regulations and ensures that each Bond fund in each state is compliant with the regulations of that state. The HFMC server(s) will issue a compliance signal to the investors and/or the SCCs and/or the banks and/or the RAC and/or the obligors and/or the EPOs when any particular Bond Series is found to be in compliance with the corresponding state/province/etc. regulations. This regulatory compliance process is repeated for groups of states/provinces/etc. when such jurisdictions share such regulations. National Bond funds are also used on a national basis, with the HFMC server(s) performing the same regulatory national compliance and issuing the same type of compliance signal.

It is important to note that the design of the health bond structure described herein differs significantly from a “factoring” or a “lending” scenario. When lending against individual receivables, in addition to underwriting the credit worthiness and credit standing of the borrower (including trying to determine if there are any third-party claims or liens or if the borrower is solvent), each individual receivable (the payment obligation of a third-party owed to the borrower which is being pledged as security and collateral for the funds being loaned and advanced) should also be underwritten. This may be a difficult task when taking into consideration the need to analyze the contractual dealings between the medical provider and the insurance company, including the accuracy of the coding and submission of claims for payment. Preferably, the subject embodiment uses the concept of “absolute sale with a warranty of merchantability” to address such issues. Instead of being a lending situation with a UCC-1/chattel mortgage security interest being perfected in each receivable that funds are lent against, receivables are indexed, identified and sold, with the fee simple transfer and an absolute assignment of all rights and interests in and to the receivable to the purchaser.

In addition to selling the receivable to the purchaser, a “warranty of merchantability” is preferably provided, with the seller (the provider who received the commitment to pay or receivable from the insurance company (provided on behalf of the actual patient/the insured)) providing a guarantee that the obligor who is responsible for satisfying and paying the receivable will, in fact pay, thus that the receivable that has been sold is indeed merchantable or has the value represented when sold and purchased for a discount against its professed value. The “warranty of merchantability” may have value to the extent that the seller is solvent or honors the obligation to make good on the contracted sales value of any receivable that they have sold.

Two alternative contractual methods for a seller to fulfill their “warranty of merchantability,” one, by providing a replacement receivable at a value adjusted to compensate for the loss of yield that would have been realized if in fact the first receivable had been paid as committed by the obligor, or to pay the amount owed in cash taking a subrogation on the unpaid receivable. A notable feature of what is being done through a purchase versus loan/factoring is that with the uncorrelated risk in regards to the purchase of the receivable which is the payment obligation of a major, investment-grade rated insurance company from the obligor, and avoiding or significantly mitigating the exposure to any credit risk relative to the seller, financial help and assistance can be provided in the form of providing immediate access to funds even in regards to even those sellers/medical providers in dire straits. In some regards the credit screening with respect to determining the viability and strength of a seller's “warranty of merchantability”, provides the opportunity to determine the overall amount of receivables to purchase from a provider/seller at any point in time, thus in some ways while the procedure is not a lending scenario it functions much like qualifying a party for a credit line.

The use of a two stage funding process utilizing the passive portfolio note mechanism is quite helpful. The use of the above described structure in conjunction with the PPNs to advance funds from the HFMC (acting as the fund manager for the respective SCCs that actually are the issuer of a the Series of HRBs), as well as the independent nature, ownership and management of the RAC (where, other than instructing and providing guidance on what will be accepted as collateral for the PPNs that the HFMC will purchase, preferably no control is exerted by the HFMC over the RACs) is important to obtain the significant tax benefit that enhances the yield by avoiding dilution due to taxation. For example, up to 30% taxation of the yield may be avoided or deferred. Preferably, the RAC obtains a tax deduction for the cost of the borrowed funds provided by and through the purchase of the secured PPNs by the HFMC on behalf of the SCCs from the RACs. There is currently no United States taxation or withholding in regards to the remission of the payment made to pay off the PPN; it is a capital appreciating debt obligation preferably owned by a non-United States entity, with no permanent business or agency presence in the United States. Thus the importance of the lack of control and independent nature of the RACs; this tax planning principal exists in many developed countries and/or states where health insurance is used.

The above-described interactions with the EPOs preferably provides them with ready access to a continuous supply of receivables to purchase. By qualifying and then providing an opportunity to a provider (whether it be a physician, a physician's practice group, hospital, laboratory, radiology or diagnostic group) to sell their receivables to an RAC, the embodiments provide a consistent and continuous source of and access to funds and capital that a provider may not have previously had. These funds are from a secured loan facility, where the only recourse offered in the case of a failure to pay due to the failure of the collateral pledged to generate the funds necessary to retire the loan obligation is to pay the obligation with other funds (inherently compounding the financials of the borrower. Due to the on-going nature of the commercial purchasing relationship and continuing confidence in the receivables being sold and the obligors related thereto, there is the opportunity to replace any defaulted receivable with another performing receivable, not necessarily detracting from immediate capital available to the seller. The distinction in recourse and difference between a lending/“factoring” type relationship and the “absolute sale with warranty of merchantability” process provides and reinforces the continuing nature of the commercial relationship as well as the availability of receivables, even potentially reducing or mitigating the marketing and promotional costs related to sourcing receivables to purchase.

Thus, there is a continuing availability of an asset class to securitize into Bonds. The above-described maturity cycle and procedures related to using the secured PPNs to collateralize and provide the asset-backed securitization for the HRBs facilitates the structuring of multi-year structures, pricing, and terms for the Bonds, as well as providing a continual stream of assets to collateralize and securitize into HRBs. The continuing nature of the inefficiency in regards to the time required to settle claims for payment between health providers and insurance companies provides ongoing confidence in the viability of HRBs. The commonality of the payment cycle problem in multiple countries and/or states where health insurance is prevalent provides significant potential for expansion of the herein-described securitization activities. The continuing likelihood of an expansion of healthcare needs, growing and aging populations, continuing disconnect between payment and timing in regard to the availability of funds for operations and capital improvements, provides the incentive for developing a primary and secondary marketplace for a long term, asset-backed preferred debt capital investment vehicle, using bond money acquired at favorable rates to take advantage of the potential for arbitrage in using funds access in this manner to acquire receivables at a discount-to-maturity-value.

Thus, when using the terms “absolute sale with a warranty of merchantability”, receivables are indexed/identified and sold, with the fee simple transfer and absolute assignment of all rights and interests in the receivable to the purchaser. In addition to selling the receivable to the purchaser, a warranty of merchantability is preferably provided, with the seller (the provider) providing a guarantee that the obligor who is responsible for satisfying and paying the receivable will in fact pay. Therefore, the receivable that has been sold is indeed merchantable or has the value represented when sold and purchased for a discount against its professed value.

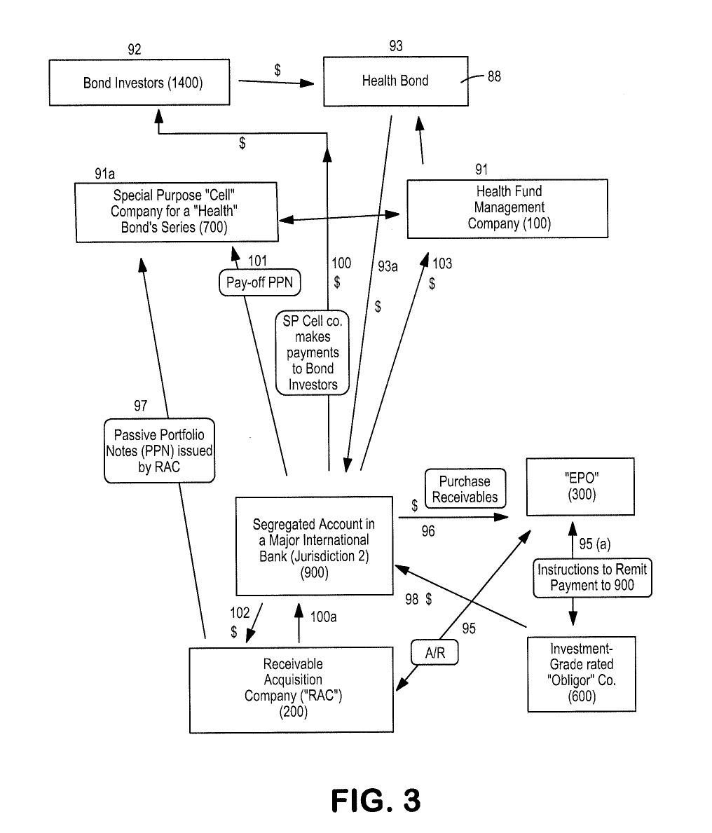

FIG. 3 depicts a functional flow chart according to another embodiment where an off-shore bank is not used (or a bank in only one jurisdiction is used). In Step 91, the HFMC 100 is provided to function as the fund manager and administrator, and to issue a Health Bond Series, including at least one Health Bond 88. In Step 91a, the HFMC also provides for an SCC 700 to issue and represent each Health Bond Series. Accredited and Institutional Investors 1400 are solicited in Step 92, and in Step 93 they invest in the Health Bond Series. In Step 93a, the proceeds from the sale of Health Bond Series are deposited into a bank in a segregated, lockbox account with, preferably, an on-shore bank 900. In Step 95, the EPO 300 sells its receivables to RAC 200, in Step 101a they are deposited in another lockbox account in bank 900, and in Step 95a, the Obligors 600 are notified in writing to remit payment to the segregated lockbox account in the bank 900. Payment for the purchase of the receivables sold by EPO 300 is made directly to the EPO from the segregated lockbox of the bank 900, in Step 96. When sufficient receivables are purchased to close out escrow (e.g., utilize all the proceeds of Health Bond Series 2015-1), a PPN is issued by the RAC 200 to the SCC 700, in Step 97. The Obligors 600 then remit payment directly into the segregated lockbox account at bank 900, in Step 98.

Upon PPN maturity, the amount needed to pay off the PPN issued by the RAC 200 is remitted from the bank 900 to the SCC 700, in Step 101; and in Step 100, the SCC 700 causes coupon and/or final payment to be made to Bond Investors 1400 from the account in bank 900. In Step 102, any origination and purchase fees earned by the RAC 200 are paid by the bank 900; and in Step 103, any administrative and management fees are paid to the HFMC 100 by the bank 900.

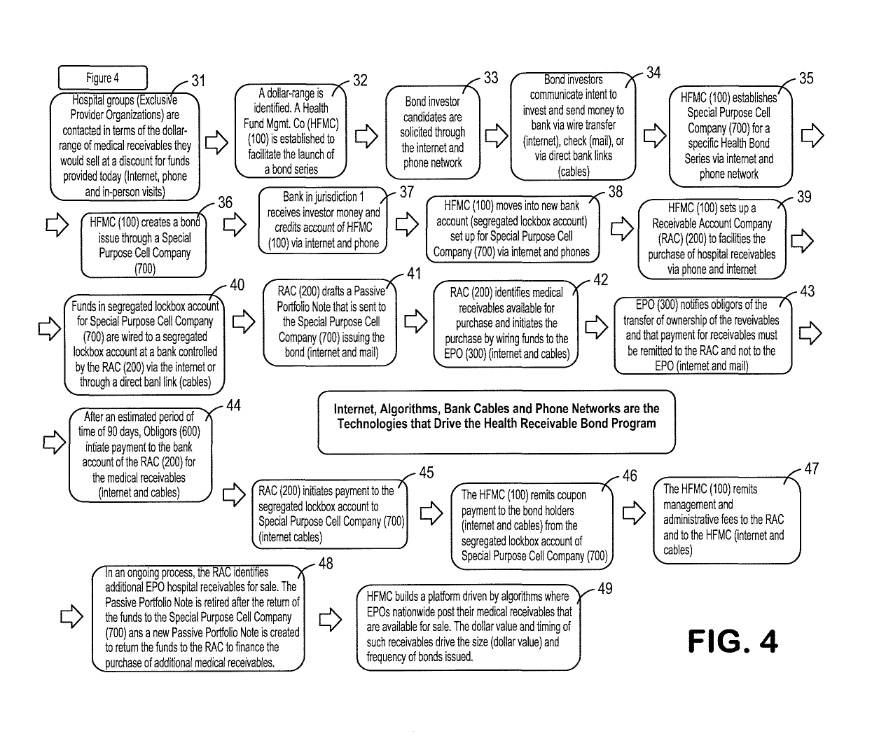

An algorithm for carrying out the processes according to the FIG. 2 embodiment is depicted in FIG. 4. This algorithm may be encoded in one or more of the servers discussed above by means of one or more permanent and/or temporary computer storage media. In Step 31, Hospital groups and/or EPOs are contacted in terms of the dollar-range of medical receivables they would sell at a discount, for funds provided today (via Internet, phone, email, and/or in-person visits). In Step 32, a dollar-range is identified, and an HFMC 100 is established to facilitate the launch of a bond series. In Step 33, bond investor candidates are solicited through the Internet, phone, email, and/or in-person visits. At Step 34, selected bond investors communicate their intent to invest, and send money to bank 800, preferably via wire transfer (Internet), check (mail), or via direct bank links (cables). In Step 35, the HFMC 100 establishes SCC 700 for a specific Health Bond Series via Internet and/or phone network.

In Step 36, the HFMC 100 creates/provides a bond issue through the SCC 700. The bank 800 in jurisdiction 1 then receives investor money via Internet and/or phone network, and credits the account of the HFMC 100, in Step 37. At Step 38, the HFMC 100 moves funds via Internet and/or phone network into a new bank account (preferably the segregated lockbox account in bank 800) that is set up for the SCC 700. In Step 39, the HFMC 100 Uses the Internet and/or phone network to set up an RAC 200 to facilitate the purchase of hospital receivables.

At Step 40, the funds in the segregated lockbox account for the SCC 700 are wired via the Internet or through secured direct bank link cables to another segregated lockbox account at a bank 900 controlled by the RAC 200. The RAC 200 drafts a PPN that is sent to the SCC 700 issuing the bond, via the Internet and/or phone network, in Step 41. At Step 42, the RAC 200 identifies medical receivables available for purchase and initiates the purchase by wiring funds to the EPO 300, via the Internet and/or phone network. Then, the EPO 300 notifies obligor(s) 600 (i) of the transfer of ownership of the receivables and (ii) that payment for receivables must be remitted to the RAC and not to the EPO, via the Internet and/or phone network, in Step 43.

After an estimated period of time of, for example, 90 days, obligors 600 initiate payment to the bank account of the RAC 200 in bank 800 for the medical receivables, via the Internet and/or secured direct bank cables, in Step 44. In Step 45, the RAC 200 uses the Internet and/or phone networks and/or secured bank cables to initiate payment to the segregated lockbox account of the SCC 700 in bank 800. The HFMC 100 then remits coupon payment to the bond holders from the segregated lockbox account of SCC 700 in bank 800 via the Internet and/or secured direct bank cables, in Step 46. The HFMC 100 then uses the Internet and/or secured direct bank cables to cause bank 800 to remit (i) the Origination and Purchase fees to the RAC 200 and (ii) Administrative and management fees to the HFMC 100, in Step 47.

In an ongoing process, in Step 48, the RAC 200 identifies additional EPO hospital receivables for sale from one or more other EPOs. The original PPN is retired after the return of the funds to the SCC 700, and a new PPN is provided to return the funds to the RAC to finance the purchase of additional medical receivables. In Step 49, the HFMC 100 preferably builds out state-wide and/or nation-wide platform(s) driven by algorithms like the above, where EPOs state-wide and/or nation-wide post their medical receivables that are available for sale. The dollar value and timing of such receivables drive the size (dollar value) and frequency of bonds issued.

### 4. Results

Numerical Example. Using the example of Health Bond Series 1 and its proposed value of $10 million, the following values are provided and transmitted via the servers and internet (and/or bank cables): (A) The $10 million proceeds generated by the sale of the Health Bond Series 1 are used to purchase one or more PPNs from the RAC at a discount-on-the-face-value of the PPN (PPNs are capital appreciating debt instruments). The PPNs may, for example, be for a face amount of $11.5 Million Dollars; (B) Funds paid to the RAC for the PPN are used to purchase medical receivables at 95% on the dollar ($1.00), generating a 5% profit on the $10 million or $500,000 each time receivables are purchased; (C) In 90 days, the full value of the medical receivable will be collected and deposited into the lockbox in the bank 800 (in jurisdiction 1). It is projected that this cycle will occur roughly four times a year (90 days×4=360 days). This means that the $10 million turns over 4 times, generating 5% on $10 million on each turn ($500,000×4 turns=$2 million). This equates to a projected total return of 20% on the $10 million each year.

In this example, the Bond's maturity is 3 years. Each PPN is preferably for a term of a year and a day, thus three consecutive PPNs will be purchased from the RAC during the three years. This means that the Bond funds transferred to a RAC will generate an estimated $2 million per year, for a period of 3 years, and each PPN will pay $1.5 Million over and above the return of the $10 million Bond principal each year and a day. The $500,000 difference between the revenue earned using the funds obtained by the RAC from the proceeds received by the SCC from the sale of the Bond and the $11.5 Million Dollar amount it had to pay to get to use the funds, is the gross profit for the RAC. The Bond owners are owed a 10% coupon each year on a principal amount of $10 Million of the Bond, thus $1 Million Dollars. $1 Million is preferably subtracted from the $1.5 Million received from the payment of the PPN (over and above the price paid for the PPN) by the RAC, to pay the annual coupon due to the Bond investors, with the HFMC retaining the balance of $500,000 of the $1.5 Million as its fund management and administrative fee.

The turnover of funds may occur on a shorter or longer time-frame than 90 days, which will have the effect of either increasing or decreasing the projected return from receivables purchased by a RAC (the return promised on the HRBs are preferably fixed; the spread earned between the acquisition of receivables and amount(s) owed (the return promised) on PPNs is gross profit of the RAC). Once the SCC 700 that represents Health Bond Series 1 receives the full value of the Bond, the RAC 200 will preferably issue a second PPN (which functions as a Promissory Note) to the same SCC 700 that represents Health Bond Series 1. The bank 800 that represents the SCC 700 that represents Health Bond Series 1, and under the direction of the HFMC 100, will preferably remit the $10 million back to the bank 900 account (in jurisdiction 2) of the RAC 200. For a three year Bond, three PPNs are acquired consecutively; for a five year Bond five PPNs are acquired consecutively, etc.

The Health Bond Series thus allows Bond investors 1400 to place capital year-after-year in a: (i) high yielding, (ii) investment-grade, (iii) high-quality, and (iv) short-term maturity, fixed-income investment. The amount of capital that can be raised through such Bond issues can approximate the aggregate value of healthcare provider's medical receivables nationwide. This is an enormous amount. Preferably, the HFMC will provide a platform where healthcare providers nationwide can post their medical receivables that are available for sale. The dollar value and timing of such receivables preferably drive the size (dollar value) and frequency of Bonds issued. The same process as described above will drive each Bond issue and subsequent purchase of receivables. Correspondingly, the HFMC will preferably license software to RACs to provide for the automated underwriting and purchasing of qualified receivables from healthcare providers, to assist RACs to originate their PPNs.

### 5. Conclusion

Thus, what had been described comprises method and/or apparatus for underwriting the delivery of healthcare services and providing capital and liquidity to healthcare providers, who accept insurance assignments and commitments, to subsequently pay for the care received by an insured patient, through the creation of a new form of securities offering, the HEALTH RECEIVABLES BOND (HRB).

Although the foregoing invention has been described in terms of certain preferred embodiments, other embodiments will become apparent to those of ordinary skill in the art in view of the disclosure herein. Accordingly, the present invention is not intended to be limited by the recitation of preferred embodiments, but is intended to be defined solely by reference to the appended claims.

What is claimed is:

1. A method of securitizing accounts receivables (A/R) of healthcare providers (HPs) which have Obligors that are obliged to make payments to the HPs for health care provided by the HPs to insured/covered persons, comprising:
providing a Health Fund Management entity (HFMe);
providing a Receivable Acquisition entity (RAe);
providing a Special Purpose Cell entity (SCe);
the SCe issuing at least one Health Receivables Bond Series (HRBS) containing Health Receivables Bonds;
at least one bond investor purchasing at least one Health Receivables Bond of the HRBS, the purchase funds being deposited in a lock box account of a first bank;
the SCe causing the funds deposited in the lock box account of the first bank to be transferred to a lock box account of a second bank;
the RAe causing the funds transferred to the lock box account of the second bank to be transferred to at least one HP in exchange for the RAe receiving A/R of the at least one HP;
the RAe issuing at least one Passive Portfolio Note (PPN) to the SCe, the PPN corresponding to the HBS;
at least one Obligor making obliged payment(s) to the lock box account of the second bank, in an account held by the RAe;
upon PPN maturity, an amount needed to pay off the PPN is remitted from the lock box account in the second bank to the lock box account in the first bank;
the SCe causing funds in the lock box account of the first bank to be provided to the at least one bond investor as Health Receivables Bond coupon and final payment(s) for the HRBS;
the SCe causing the PPN for the HRBS for which it was issued to be paid off by transfer of funds from the lock box account of the first bank to the SCe;
the SCe causing financial fees to be paid to the RAe from the lock box account of the first bank; and
the SCe causing administrative fees to be paid to the HFMe from the lock box account of the first bank.

2. A method of securitizing accounts receivables (A/R) of healthcare providers (HPs) which have Obligors that are obliged to make payments to the HPs for health care provided by the HPs to insured/covered persons, comprising:
at least one HP selling its A/R to an independent Receivable Acquisition entity (RAe) at a discount from face value of the HP A/R;
the RAe generating Bond funds from investors who wish to purchase HP A/R Bonds;
the RAe receiving the obliged payments from the Obligors at the face value of the HP A/R; and
the investors receiving coupon and final payments from the HP A/R Bonds.

3. Apparatus for securitizing accounts receivables (A/R) of healthcare providers (HPs) which have Obligors that are obliged to make payments to the HPs for health care provided by the HPs to insured/covered persons, comprising:
at least one Health Fund Management entity (HFMe) server;
at least one Receivable Acquisition entity (RAe) server;
at least one Special Purpose Cell entity (SCe) server, the at least one SCe server transmitting signals corresponding to the issuance of at least one Health Receivables Bond Series (HRBS) containing at least one Health Receivables Bond, the at least one SCe server receiving signals from at least one server of at least one bond investor, the received signals corresponding the a purchase of at least one Health Receivables Bond of the HRBS, the received signals also indicating that the purchase funds are deposited in a lock box account of a bank;
the at least one RAe server transmitting signals which cause the funds transferred to the lock box account of the bank to be transferred to at least one HP in exchange for the at least one RAe server receiving signals corresponding to the A/R of the at least one HP, the at least RAe server transmitting signals corresponding to the issuing of at least one Passive Portfolio Note (PPN) to the at least one SCe server, the PPN corresponding to the HBS;
the at least one SCe server receiving signals indicating that at least one Obligor has made obliged payment(s) to the lock box account of the second bank, in an account held by the RAe;
upon PPN maturity, the at least one SCe server transmits signals causing funds in the lock box account of the bank to be provided to the at least one server of the at least one bond investor as Health Receivables Bond coupon and final payment(s) for the HRBS, the at least one SCe server issuing signals causing the PPN for the HRBS for which it was issued to be paid off by transfer of funds from the lock box account of the bank to the at least one SCe server; and
the at least one SCe server transmitting signals causing at least one of (i) financial fees to be paid to the at least one RAe server from the lock box account of the bank and (ii) causing administrative fees to be paid to the at least one HFMe server from the lock box account of the bank.
